(19) United States
(12) Patent Application Publication
(10) Pub. No.: US 2019/0029445 A1
(43) Pub. Date: Jan. 31, 2019

(54) HOLDER OPTIMIZED FOR VIEWING AND BROWSING DISPLAY CONTENT AND METHODS OF MANUFACTURING SAID HOLDER

(71) Applicant: BAD HAIR LLC, Chicago, IL (US)

(72) Inventor: Benjamin ROBERTSON, CHICAGO, IL (US)

(73) Assignee: Bad Hair LLC, Chicago, IL (US)

(21) Appl. No.: 16/073,785

(22) PCT Filed: Jan. 28, 2017
(86) PCT No.: PCT/US17/15522

§ 371 Date: Jul. 28, 2018

Related U.S. Application Data
(60) Provisional application No. 62/289,163, filed on Jan. 29, 2016.

(51) Int. Cl. A47F 7/00; A47F 5/10; A47F 5/00; B21D 5/16; B29C 53/36; B29C 53/80

(52) U.S. Cl. CPC A47F 7/0042; A47F 5/10; A47F 5/0025; G09F 5/02; B29C 53/36; B29C 53/80; B21D 5/16

(57) ABSTRACT

A holder for display content is described. The display holder includes a main section, a first side panel, and a second side panel. The main section provides a base, a back panel, and a front panel. The back panel protrudes from a back edge of the base at an angle between about 45 degrees and about 70 degrees. The front panel protrudes from a front edge of the base and is at least 67% shorter than the back panel. The first side panel is attached to a first edge of the main section and the second side panel is attached to a second edge of the main section. The main section, the first side panel, and the second side panel define a recess for receiving the display content.

### TECHNICAL FIELD

The present invention relates to a holder. More specifically, the invention relates to a display holder for content such as vinyl records in screen covers, and methods of manufacturing said holder. The holder allows for viewing and browsing of the content and can be used for personal or commercial purposes.

### SUMMARY

Holders for vinyl records, compact discs, comic books, collectible cards, brochures, and other content are commonly displayed in stores, personal homes, and the like. These holders, however, focus on prominently displaying (e.g., for viewing and browsing) on the top held material. Therefore, a holder is needed that allows a person to easily view and browse all the held materials. Also, the surface area occupied by the holder should be minimized in order to increase the amount of holders that can be placed on a surface while also maximizing ease of browsing and viewing materials held therein.

The present invention relates to a holder for display content. The holder includes a main section, a first side panel, and a second side panel. The main section provides a base, a back panel, and a front panel. The back panel protrudes from a back edge of the base at an angle between 45 degrees and approximately 70 degrees. The front panel protrudes from a front edge of the base and is at least 67% shorter than the back panel. The first side panel is attached to a first edge of the main section and the second side panel is attached to a second edge of the main section. The main section, the first side panel, and the second side panel define a recess for receiving the display content.

The present invention further relates to provides for a method of manufacturing the holder. A shape of the holder, including a main section, a first side panel, and a second side panel, is cut from a sheet metal, wherein the main section includes a base, a back panel, and a front panel. The back panel is folded towards the base along a back edge of the base, and the front panel is folded towards the base along a front edge of the base. The first side panel is folded along a first edge towards the main section, and attached to the main panel along the first edge. The second side panel is folded along a second edge towards the main section, and attached to the main panel along the second edge.

The present invention even further relates to a holder wherein the holder is composed of at least one of plastic, metal, wire mesh, or wood, or a combination of the same. In other embodiments, a kickstand is attached to the back panel and positioned to support the holder. In yet other embodiments, the first side panel and the second side panel are separable from the main section.

Other advantages and features of the disclosure will become apparent upon review of the detailed description and accompanying drawings.

### BRIEF DESCRIPTION OF THE DRAWINGS

FIGS. 1A through 1D illustrate perspective views of a display holder, in accordance with the principles of the present invention;

FIG. 2 illustrates a side view of the display holder, in accordance with the principles of the present invention;

FIG. 3 illustrates an assembly view of the display holder, in accordance with the principles of the present invention;

FIGS. 4A and 4B illustrates perspective views of the display holder, in accordance with the principles of the present invention;

FIGS. 5A and 5B illustrate an assembly view of the display holder, in accordance with the principles of the present invention;

FIGS. 6A and 6B illustrate various views of a kickstand of the display holder, in accordance with the principles of the present invention;

FIG. 6C illustrates a perspective view of a display holder, in accordance with the principles of the present invention;

FIGS. 7A and 7B illustrate various views of the kickstand of the display holder, in accordance with the principles of the present invention;

FIG. 8 illustrates an exploded view of the display holder, in accordance with the principles of the present invention; and

FIGS. 9A and 9B illustrate various views of the display holder, in accordance with the principles of the present invention.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

Accordingly, the detailed discussion herein of one or more embodiments is not intended, nor is to be construed, to limit the metes and bounds of the patent protection afforded the present invention, in which the scope of patent protection is intended to be defined by the claims and equivalents thereof. Therefore, embodiments not specifically addressed herein, such as adaptations, variations, modifications, and equivalent arrangements, should be and are considered to be implicitly disclosed by the illustrative embodiments and claims described herein and therefore fall within the scope of the present invention.

Additionally, it is important to note that each term used herein refers to that which a person skilled in the relevant art would understand such term to mean based on the contextual use of such term herein. To the extent that the meaning of a term used herein, as understood by the person skilled in the relevant art based on the contextual use of such term, differs in any way from any particular dictionary definition of such term, it is intended that the meaning of the term as understood by the person skilled in the relevant art should prevail.

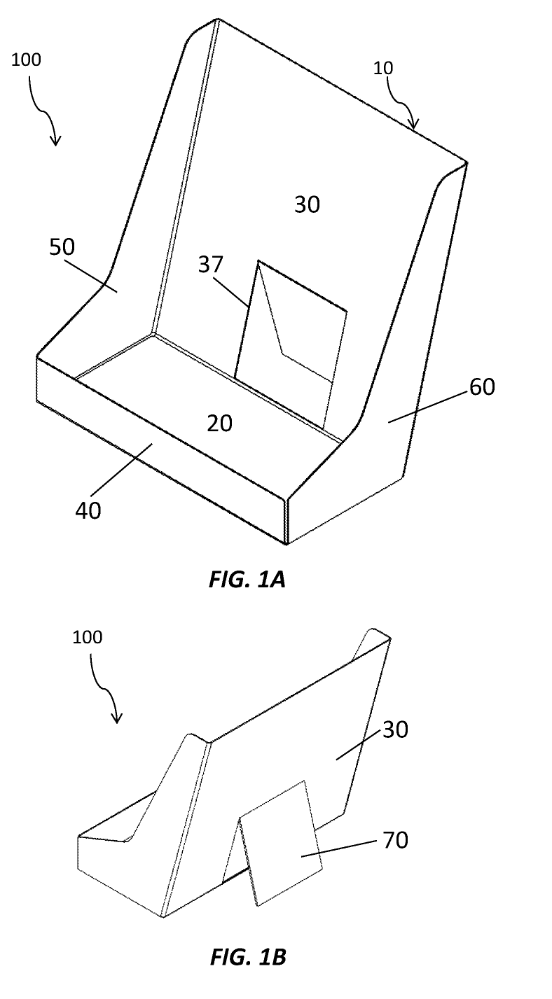

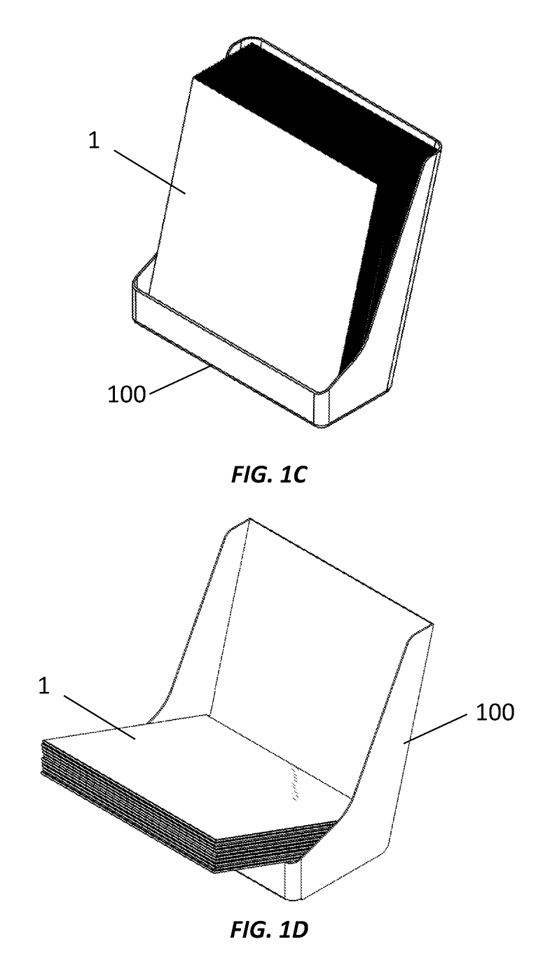

FIGS. 1A through 1D illustrate a display holder 100 (i.e., display stand, display bin, etc.) in accordance with a first embodiment of the present invention. FIG. 1A illustrates a forward perspective view of the holder 100. The holder 100 includes a main section 10 that provides a base 20, a back panel 30, and a front panel 40. The base 20 of the holder 100 can be placed on a flat surface, such as a table, shelf, etc. In some embodiments, the back panel 30 includes an opening 37. The holder 100 further includes a first side panel 50 and a second side panel 60. The main section 10, the first side panel 50, and the second side panel 60 define a recess for receiving display content.

FIG. 1B illustrates a reverse perspective view of the holder 100. In this embodiment, a kickstand 70 is attached to the back panel 30. The kickstand 70 is configured to support the holder 100. In FIG. 1B, the kickstand 70 is formed from and contiguous with the opening 37 (shown in FIG. 1A) of the back panel 30.

The holder 100 can be formed from a variety of suitable materials including, but not limited to, plastic, metal, and wood, and a combination thereof. For example, the material(s) could be, but are not limited to polyethylene, polyurethane, aluminum, brass, steel, iron, iron alloys, plywood, walnut, oak, cedar, corrugated cardboard, corrugated plastic, wire mesh, or even metal grill. It may be understood that the term “material” is used herein to indicate any substantially two-dimensional material suitable for incorporation into a holder, stand, or bin, including other rigid materials.

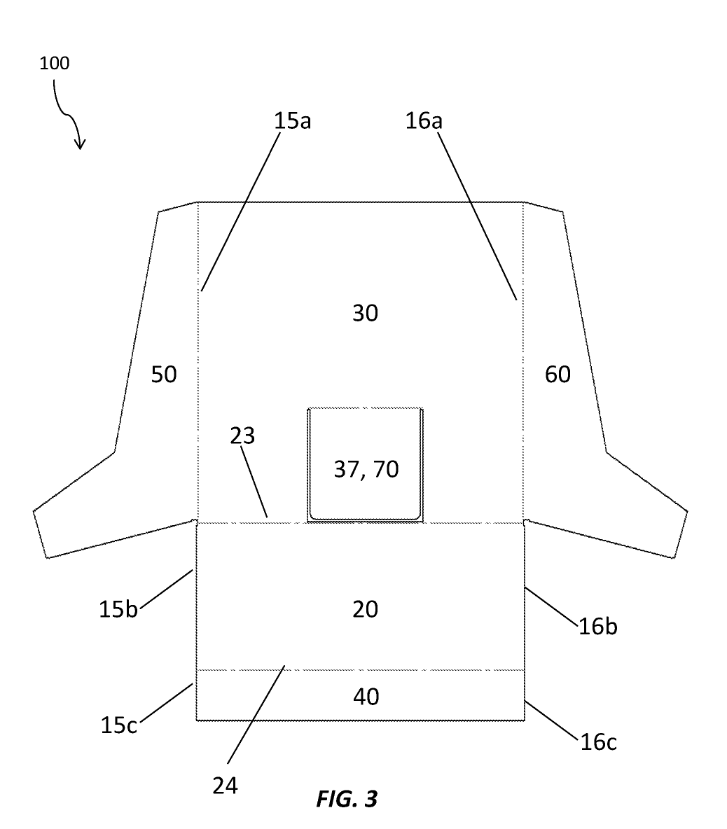

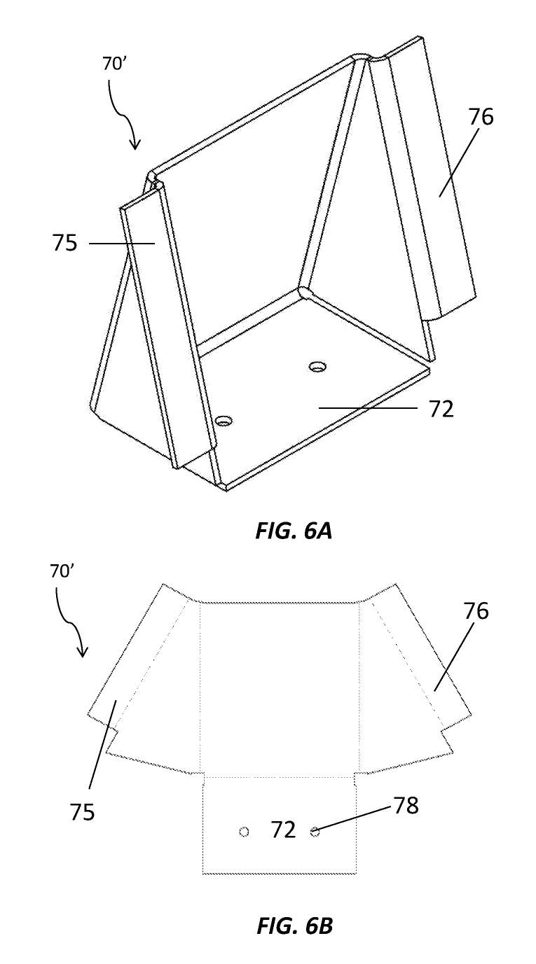

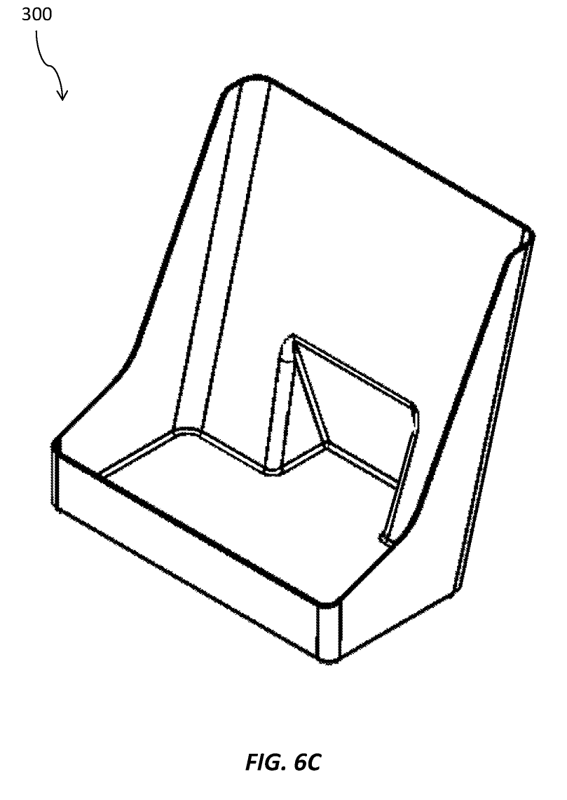

The holder 100 can be formed using a variety of suitable manufacturing methods including, but not limited to, molding, folding, and extruding. In an exemplary embodiment, the holder 100 is made from plastic that is melted and molded (e.g., poured into a form and cooled) into appropriate dimensions and shape. In another exemplary embodiment, the holder 100 is made from a sheet of plastic that is cut and folded into the appropriate dimensions and shape (see descriptions of FIGS. 3 and 6C for further detail). In yet another embodiment, the main section is extruded from plastic and the side panels 50, 60 are cut from sheet plastic; the side panels 50, 60 are attached (e.g., by melting, using an adhesive, etc.) to the main section 10.

In an exemplary embodiment, the holder 100 is made from metal that is melted and extruded until the appropriate dimensions and shape. In another exemplary embodiment, the holder 100 is made from a sheet of metal that is cut and folded into the appropriate dimensions and shape. In yet another embodiment, the main section is extruded from metal and the side panels 50, 60 are cut from sheet metal; the side panels 50, 60 are attached by means known in the art, including but not limited to, by welding, using an adhesive, using at least one screw and/or nail, to the main section 10. It may be understood that the holder 100 can be manufactured using one or more of the disclosed manufacturing methods or any suitable manufacturing method for rigid materials.

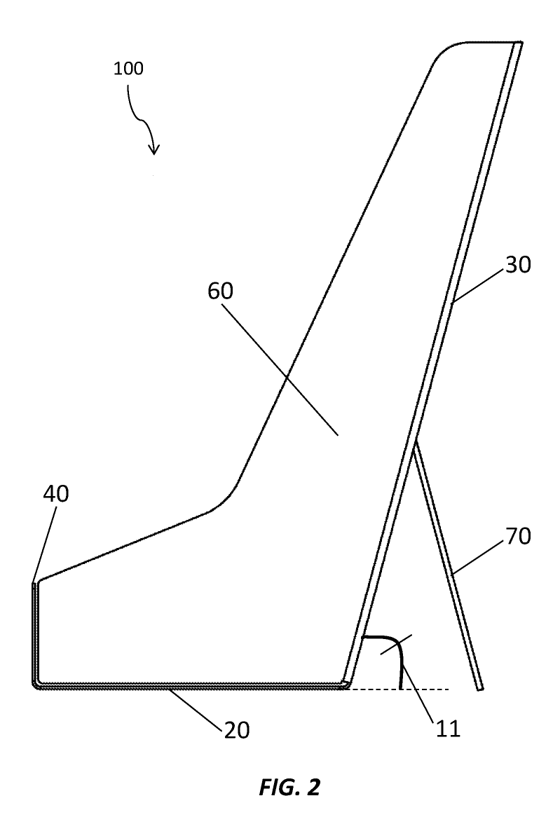

In general, FIG. 1C illustrates the holder 100 used to receive or support display content 1. The display content 1 can be, for example, a vinyl record in a screen cover including, for example but not limited to, 7 inch records and/or 12 inch records, a compact disc in a plastic case, a comic book, a collectible card, a brochure, a magazine, and the like. The recess defined by the main section 10 and the side panels 50, 60 receives at least one of the display content 1. In some embodiments, the holder 100 is configured to receive approximately 35 vinyl records. As shown in FIG. 1C, the display content 1 is, in a first position, primarily supported by the back panel 30 of the holder 100. The shape (see description of FIG. 2 for further detail) of the holder 100 is optimized so that the display content 1 can be easily viewed by a person standing in front of the holder 100 and looking down towards the display content 1.

Alternatively, FIG. 1D illustrates the display content 1 supported in a second position by the front panel 40 of the holder 100. A person standing in front of the holder 100 and looking down towards the display content 1 may change the position of at least one display content 1 to be supported by the front panel 40 so that the larger surface area allows other display content 1 to be more visible and viewable. Thus a plurality of display content 1 is easily accessible and browsing is facilitated.

FIG. 2 illustrates a side view of the holder 100. The second side panel 60 is generally L-shaped, but it is to be understood that other shapes are also contemplated and the side panel 50, 60 shape is not intended to be limited to a generally L-shape. Additionally, various features (e.g., rounding, edging, etc.) can be added to a general shape of the side panels 50, 60. The back panel 30 protrudes from the base 20 (not shown) at an angle 11 between 45 degrees and approximately 80 degrees from a horizontal plane defined by the base 20. For example, in one embodiment, the angle is about 77 degrees (i.e., 13 degrees from vertical). Making the angle 11 between 45 degrees and approximately 80 degrees enables a person to see a face of the display content 1 (not shown) and reduces the amount of space required to store the display content 1. The front panel 40 protrudes from the base 20 substantially orthogonally (i.e., perpendicularly) from the horizontal plane defined by the base 20. The front panel 40 keeps the display content 1 within the recess defined by the main section 10 and the side panels 50, 60. In order to provide the person with a view of the face of the display content 1, the front panel 40 is substantially shorter than the back panel 30. In some embodiments, the front panel 40 is 67% shorter than the back panel 30.

For example, in an embodiment of the holder 100 for displaying vinyl records in screen covers (i.e., the display content 1), the first side panel 50 is spaced approximately 13 inches (i.e., 12.75 inches) from the second side panel 60; the back panel 30 extends between the side panels 50, 60. The screen covers of vinyl records are slightly smaller than 13 inches and the holder 100 snuggly yet accessibly accommodates the screen covers. The back panel 30 is between 9 and 12 inches (e.g., 10.88 inches) tall (i.e., measured from the base to a distal end of the back panel 30) to support the display content 1. The front panel 40 is less than about 3.59 inches (i.e., 67% shorter than the back panel 30; e.g., 2.00 inches) tall. The base 20, extending between the back panel 30 and the front panel 40, is about 6 inches (i.e., 5.64 inches) long to support a plurality of display content 1.

The dimensions of the holder 100 can be changed to accommodate other display content 1. In some embodiments, the display holder dimensions are configured to receive 7 inch vinyl records and/or 12 inch vinyl records. For example, the dimensions of the holder 100 would be smaller to receive a compact disc, a collectible card, or a comic book in the recess defined by the main section 10 and the side panels 50, 60.

FIG. 3 illustrates an assembly view of the holder 100. The base 20 has a back edge 23 and a front edge 24. The back panel 30 protrudes from the back edge 23 of the base 20 and the front panel 40 protrudes from the front edge 24 of the base 20. The first side panel 50 protrudes from a first edge 15a of the back panel 30. In other embodiments, the first side panel 50 may protrude from a first edge 15b of the base 20 or from a first edge 15c of the front panel 40. Similarly, the second side panel 60 protrudes from a second edge 16a of the back panel 30. In other embodiments, the second side panel 60 may protrude from a second edge 16b of the base 20 or from a second edge 16c of the front panel 40.

For subsequent disclosure, the first edge 15a-15c and the second edge 16a-16c have been referred to in their complete/assembled form. In its assembled form, the holder 100 may be understood to have a first edge 15 (previously being the first edge 15a, 15b, and 15c) and a second edge 16 (previously being the second edge 16a, 16b, 16c). As illustrated, the first edge 15 and the second 16 are at opposite ends of the main section. When constructed, the first side panel 50 and the second side panel 60 are completely attached to the first edge 15 and the second edge 16, respectively (as illustrated in FIGS. 1A through 1C).

As previously discussed with respect to FIG. 1B, the holder 100 can be manufactured from a variety of materials (e.g., plastic, metal, wood, and a combination thereof, etc.) using a variety of manufacturing methods. The following exemplary embodiment uses folding to assemble material previously cut. During assembly, the main section 10 (i.e., the base 20, the back panel 30, and the front panel 40) is formed by folding the material (e.g., plastic, metal, etc.) along the back edge 23 and the front edge 24 to create the shape illustrated in FIGS. 1A, 1B, and 2. The back panel 30 is folded towards the base 20 in a first direction, and the front panel 40 is folded towards the base 20 in a second direction, wherein the second direction is opposite the first direction. The angle 11 between the back panel 30 and the horizontal plane defined by the base 20 is created by folding along the back edge 23. In some embodiments, the holder 100 is composed of corrugated cardboard and/or plastic; a user purchases the holder 100 in an unassembled form (as depicted in FIG. 3). The user assembles (i.e., folds, forms, attaches, etc.) the holder 100 into the shape depicted in FIGS. 1A, 1B, and 2.

Referring to FIG. 3, the first side panel 50 protrudes from the first edge 15a of the back panel 30 and the second side panel 60 protrudes from the first edge 16a of the back panel 30. After folding (e.g., in a third and fourth direction, each orthogonal to the first direction, wherein the fourth direction is opposite the third direction), the side panels 50, 60 are substantially close to the remainder of the side edges 15b, 15c and 16b, 16c, respectively. The side panels 50, 60 can be attached to the portions of the side edges 15, 16 from which they do not protrude. In one embodiment, the side panels 50, 60 are attached to the side edges 15, 16 by melting the material near the side edges 15, 16. In another embodiment, the side panels 50, 60 are attached to the side edges 15, 16 by welding the material near the side edges 15, 16. In yet another embodiment, the side panels 50, 60 are attached to the side edges 15, 16 using adhesive on the material near the side edges 15, 16. After allowing time for the attachment to form (i.e., cool, set, settle), the holder 100 is ready for use with display content 1.

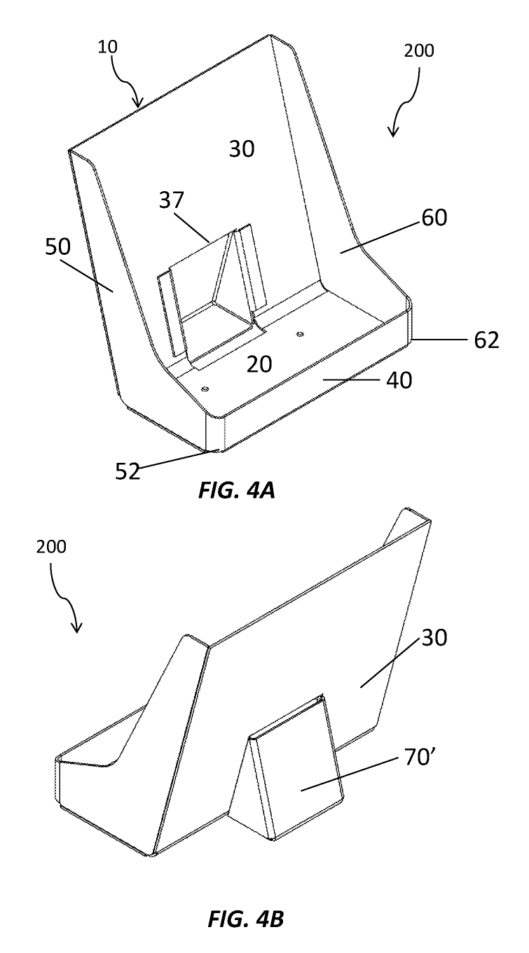

FIGS. 4A and 4B illustrate a display holder 200 (i.e., display stand, display bin, etc.) in accordance with a second embodiment of the present invention. FIG. 4A illustrates a forward perspective view of the holder 200. The holder 200 includes a main section 10 that provides a base 20, a back panel 30, and a front panel 40. The base 20 of the holder 200 can be placed on a flat surface, such as a table, shelf, etc. In some embodiments, the back panel 30 includes an opening 37. The holder 200 further includes a first side panel 50 and a second side panel 60. The main section 10, the first side panel 50, and the second side panel 60 define a recess for receiving display content 1.

In some embodiments, the holder 100 includes a first cut-out 52 and a second cut-out 62. The cut-outs 52, 62 are formed in the corners between the side panels 50, 60 and the main panel 10, respectively. The cut-outs 52, 62 are configured to receive a corner of the display content 1 (not shown), and provide better support. In some embodiments, more cut-outs 52, 62 are included (e.g., to receive and support the display content 1 in the second position depicted in FIG. 1D).

FIG. 4B illustrates a reverse perspective view of the holder 200. In some embodiments, a kickstand 70′ is attached (e.g., removable and/or permanently) to the back panel 30. The kickstand 70′ is positioned to support the holder 200. In FIG. 4B, the kickstand 70′ is formed from a piece of material separate from the holder 200. In some embodiments, no kickstand 70′ is provided, for example, if the holder 200 is wall-mounted.

As previously disclosed with respect to FIG. 1B, the holder 200 can be formed from a variety of suitable materials including, but not limited to, corrugated (e.g., cardboard and/or plastic), plastic (e.g., polyethylene), metal (e.g., aluminum), and wood (e.g., plywood), and a combination thereof. Additionally, the holder 200 can be formed using a variety of suitable manufacturing methods including, but not limited to, molding, folding, and extruding.

As previously disclosed with respect to FIG. 2, the side panels 50, 60 are generally L-shaped. The back panel 30 protrudes from the base 20 at an angle 11 between 45 degrees and approximately 70 degrees from a horizontal plane defined by the base 20. The front panel 40 protrudes the base 20 at a substantially orthogonal (i.e., perpendicular) from the horizontal plane defined by the base 20. The front panel 40 is substantially shorter than the back panel 30. In some embodiments, the front panel 40 is 67% shorter than the back panel 30.

Referring to FIGS. 4A and 4B, in an embodiment of the holder 200 for displaying vinyl records in screen covers or the display content 1, the holder 200 is provided with panels spaced at distances adapted to support the display content 1. For example, in the embodiments of FIGS. 4A and 4B, the first side panel 50 is spaced approximately 13 inches (i.e., 12.75 inches) from the second side panel 60; the back panel 30 extends between the side panels 50, 60. The back panel 30 is between 9 and 12 inches (e.g., 10.88 inches) tall, measurements taken from the base to a distal end of the back panel 30, to support the display content 1. The front panel 40 is less than about 3.59 inches (i.e., 67% shorter than the back panel 30; e.g., 2.00 inches) tall. The base 20, extending between the back panel 30 and the front panel 40, is about 6 inches (i.e., 5.64 inches) long to support a plurality of display content 1.

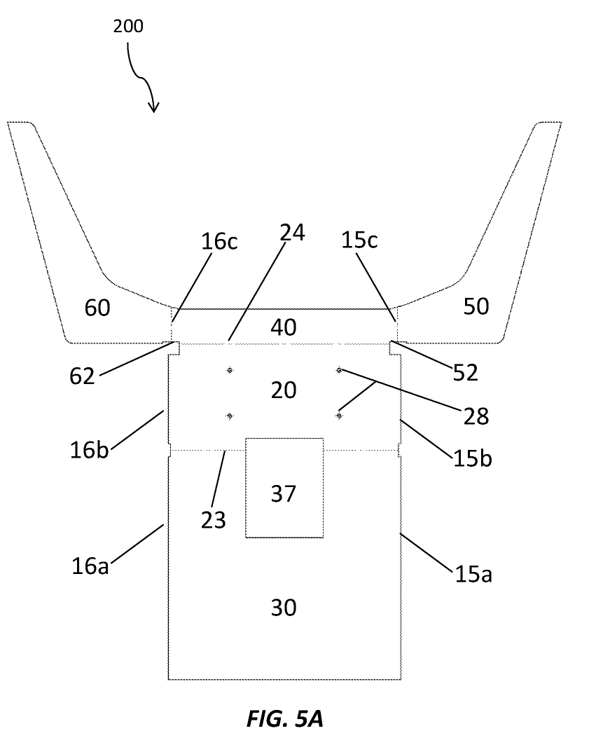

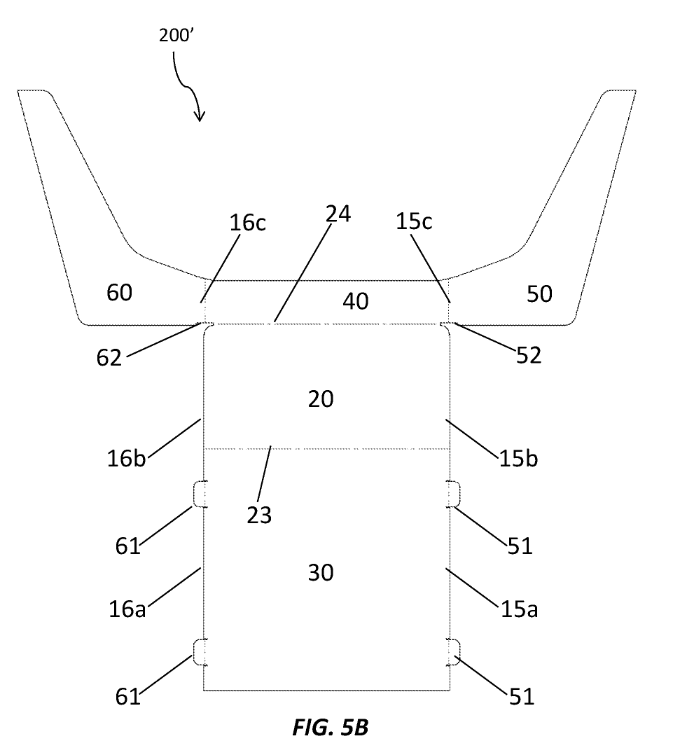

FIG. 5A illustrates an assembly view of the holder 200. The base 20 has a back edge 23 and a front edge 24. The back panel 30 protrudes from the back edge 23 of the base 20 and the front panel 40 protrudes from the front edge 24 of the base 20. The first side panel 50 protrudes from a first edge 15c of the front panel 40. In other embodiments, the first side panel 50 may protrude from a first edge 15a of the back panel 30 or from a first edge 15b of the base 20. Similarly, the second side panel 60 protrudes from a second edge 16c of the front panel 40. In other embodiments, the second side panel 60 may protrude from a second edge 16a of the back panel 30 or from a second edge 16b of the base 20. The holder 200 can include the first cut-outs 52 and the second cut-outs 62 between the base 20, the front panel 40, and/or the side panels 50, 60.

In some embodiments, the holder 200 further includes at least one rubber pad 28. The at least one rubber pad is operable to grip the surface on which the holder 200 is placed. In other embodiments, the holder 200 includes feet (not shown) that are removably attached to the base 20. The at least one rubber pad (or the feet) can be composed of a variety of material(s) including, but not limited to, wool, cotton, metal, rubber, plastic, etc.

The following exemplary embodiment uses folding to assemble material previously cut. During assembly, the main section 10 (i.e., the base 20, the back panel 30, and the front panel 40) is formed by folding the material (e.g., plastic, metal, etc.) along the back edge 23 and the front edge 24 to create the shape illustrated in FIGS. 4A and 4B. The back panel 30 is folded towards the base 20 in a first direction, and the front panel 40 is folded towards the base 20 in a second direction, wherein the second direction is opposite the first direction. The angle 11 between the back panel 30 and the horizontal plane defined by the base 20 is created by folding along the back edge 23.

Referring to FIG. 5A, the first side panel 50 protrudes from the first edge 15c of the front panel 40 and the second side panel 60 protrudes from the first edge 16c of the front panel 40. After folding, the side panels 50, 60 are substantially close to the remainder of the side edges 15a, 15b and 16a, 16b, respectively. The side panels 50, 60 can be attached to the portions of the side edges 15, 16 from which they do not protrude. As previously disclosed, the side panels 50, 60 are attached to the side edges 15, 16 by melting, by welding, or by using adhesive on the material near the side edges 15, 16.

FIG. 5B illustrates an assembly view of a holder 200′. The holder 200′ is similar to the holder 200 depicted in FIG. 5A. Additional features include, but are not limited to, at least one first tab 51 and at least one second tab 61. The at least one first tab 51 is operable to attach (e.g., using adhesive) the back panel 30 to the first side panel 50, and the at least one second tab 61 is operable to attach the back panel to the second side panel 60. A person skilled in the art would understand that the placement of the tabs 51, 61 can be adjusted along the first edge and the second edge of the holder 200′. The cutouts 52, 62 of FIG. 5B are also a different shape than the cutouts 52, 62 of FIG. 5A.

FIGS. 6A through 6B illustrate the kickstand 70′ of the holder 200. FIG. 6A illustrates a forward perspective view of the kickstand 70′. A base 72 of the kickstand 70′ can be placed on a flat surface, such as a table, shelf, etc. A first side overlap 75 and a second side overlap 76 can be inserted into the opening 37 of the holder 200. The overlaps 75, 76 are then attached to the holder 200 using any of the attachment methods previously disclosed.

FIG. 6B illustrates an assembly view of the kickstand 70′. The kickstand 70′ is assembled in a similar order and method as the holder 200 illustrated in FIGS. 4A and 4B. In some embodiments, the kickstand 70′ includes at least one rubber pad 78 for gripping the surface on which the base 72 is placed.

FIG. 6C illustrates a perspective view of a holder 300, according to a third embodiment of the present invention. In this embodiment, a kickstand is formed as part of the panels. For example, the holder 300 is manufactured by molding plastic. The kickstand (e.g., similar to kickstand 70′ of FIGS. 6A and 6B) is not removable.

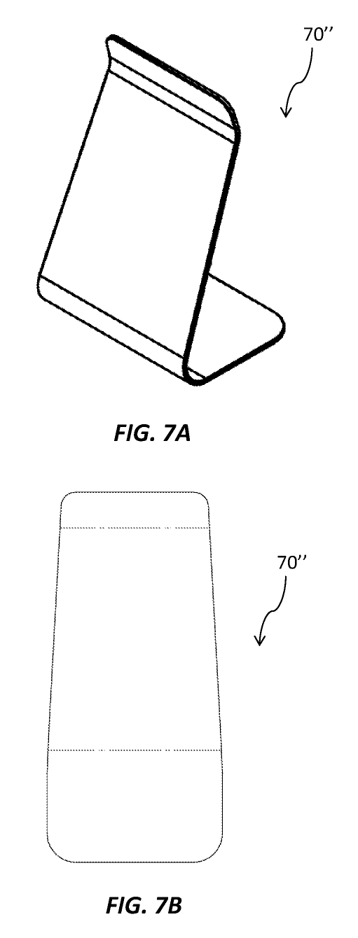

FIG. 7A illustrates a perspective view of a kickstand 70″. The kickstand 70″ can be used with holders 100 or 200, and attached to holders 100 or 200 using the attachment methods previously disclosed. In some embodiments, the kickstand 70″ is removable attached (e.g., using a magnetic material and/or components, using an adhesive, etc.) In other embodiments, the kickstand 70″ is welded to the holders 100, 200. In another embodiment (not illustrated), the kickstand 70, 70′, 70″ may be replaced by a wall mount for the holders 100 or 200.

FIG. 7B illustrates an assembly view of the kickstand 70″. The kickstand 70″ is assembled in a similar order and method as the kickstand illustrated in FIGS. 6A and 6B. In some embodiments, the kickstand 70″ includes at least one rubber pad 78 (not shown) for gripping the surface on which the base 72 is placed.

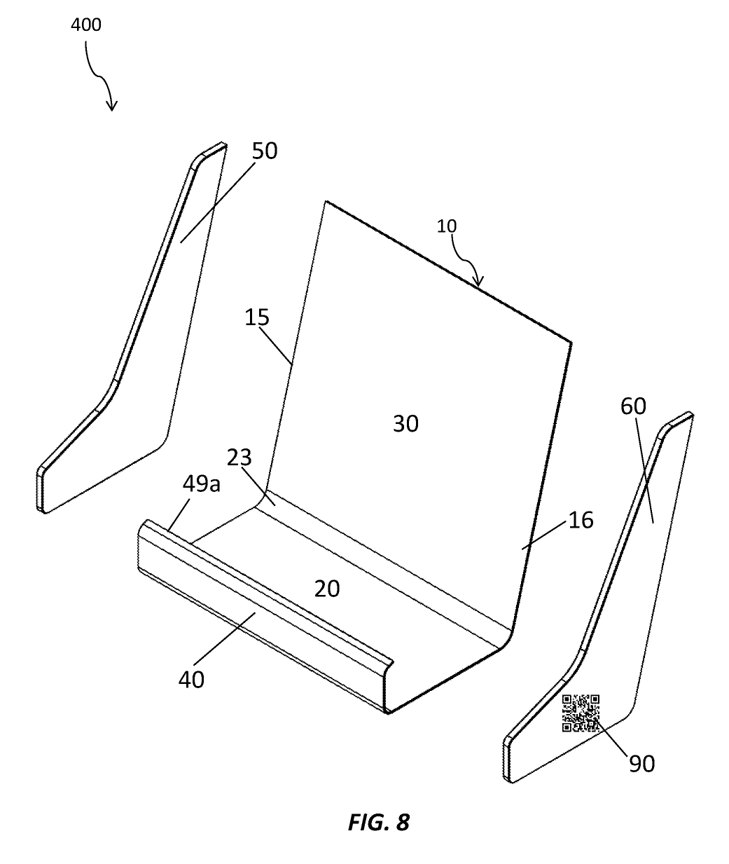

FIG. 8 illustrates an exploded view of a display holder 400 (i.e., display stand, display bin, etc.) in accordance with a fourth embodiment of the present invention. The main section 10 (comprised of the base 20, the back panel, and the front panel 40) is composed of a first material (e.g., plastic) and the side panels 50, 60 is composed of a second material (e.g., metal). The base 20 may include a rounded edge 23 (i.e., back edge 23). The front panel 40 may include a lower lip 49a (i.e., fold) and an upper lip 49b. In some embodiments, the side panel 60 includes a QR code 90. The QR code 90 can be read by a cellular device (not shown), opening an application (e.g., a web browser) that displays an image of the display content 1 (e.g., album cover art). The user of the holder 400 can add data to the application opened via the QR code to reflect the display content 1 currently received by the holder 400.

Referring to FIG. 8, in one embodiment, the first side panel 50 and the second side panel 60 of the holder 400 are manufactured by cutting a material (e.g., plastic, metal, etc.). The side panels 50, 60 are attached to the main section 10, using any of the attachment methods previously disclosed, along the side edges 15, 16, respectively. In some embodiments, the side panels 50, 60 are composed of a material different than the main panel 10.

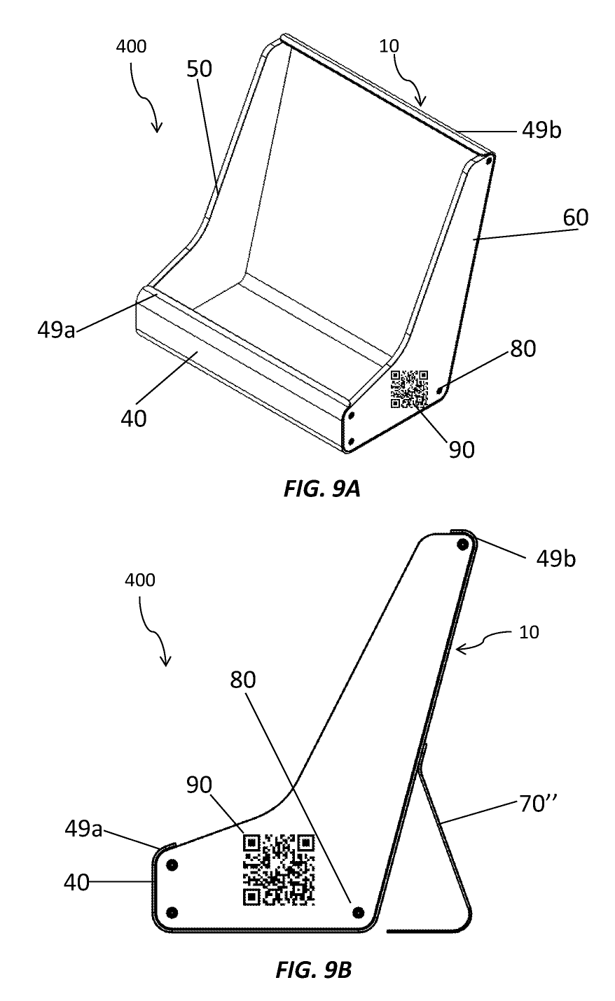

FIGS. 9A and 9B illustrate a perspective view and a side view, respectively, of the holder 400. In some embodiments, the side panels 50, 60 include holes 80. The holes 80 are operable to receive a screw and/or nail to attach the side panels 50, 60 to the main panel 10. The kickstand 70″ can be removably or permanently attached to the holder, as previously described with respect to FIGS. 7A and 7B.

As to the manner of usage and operation of the present invention, the same should be apparent from the above description. Accordingly, no further discussion relating to the manner of usage and operation will be provided.

While an embodiment of the holder has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent to one skilled in the art, and all equivalent relationships to those illustrated in the drawings and described in the specification are intended to be encompassed by the present invention.

Throughout this specification, unless the context requires otherwise, the word “comprise” or variations such as “comprises” or “comprising” or the term “includes” or variations, thereof, or the term “having” or variations thereof will be understood to imply the inclusion of a stated element or integer or group of elements or integers but not the exclusion of any other element or integer or group of elements or integers. In this regard, in construing the claim scope, an embodiment where one or more features is added to any of the claims is to be regarded as within the scope of the invention given that the essential features of the invention as claimed are included in such an embodiment.

Those skilled in the art will appreciate that the invention described herein is susceptible to variations and modifications other than those specifically described, and that each embodiment is also provided with features that may be applicable to other embodiments. It is to be understood that the invention includes all such variations and modifications that fall within its spirit and scope. The invention also includes all of the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A holder for display content, the holder comprising:
a main section including a base, a back panel, and a front panel, wherein the back panel protrudes from a back edge of the base at an angle between about 45 degrees and about 70 degrees, the front panel protrudes from a front edge of the base, and the front panel is at least 67% shorter than the back panel;
a first side panel attached to a first edge of the main section; and
a second side panel attached to a second edge of the main section, wherein the main section, the first side panel, and the second side panel define a recess for receiving the display content.

2. The holder of claim 1, wherein the main section, the first side panel, and the second side panel are composed of a material selected from the group consisting of plastic, metal, and wood, and a combination of materials.

3. The holder of claim 2, wherein the material is plastic and the holder is manufactured using a method selected from the group consisting of molding and extruding.

4. The holder of claim 2, wherein the material is metal and the holder is manufactured using a method selected from the group consisting of folding and extruding.

5. The holder of claim 1, further comprising a kickstand attached to the back panel and positioned to support the holder.

6. The holder of claim 5, wherein the kickstand is attached to an opening in the back panel.

7. The holder of claim 6, wherein the kickstand is formed from a cut portion of the back panel.

8. The holder of claim 1, wherein the first side panel and the second side panel are separable from the main section.

9. The holder of claim 1, wherein the distance between the first edge of the main section and the second edge of the main section is between 10 inches and approximately 13 inches wide.

10. The holder of claim 9, wherein the display content is at least one vinyl record sleeve cover and the recess is operable to receive the at least one vinyl record sleeve cover.

11. The holder of claim 10, wherein the at least one vinyl record sleeve cover is supported by the back panel in a first position and supported by the front panel in a second position.

12. The holder of claim 1, further comprising a lip one of the front panel and the back panel.

13. The holder of claim 12, wherein the lip is configured to hold the display content within the recess.

14. The holder of claim 1, further comprising a QR code on one of the first side panel and the second side panel, the QR code configured to be read by a cellular device.

15. A method for manufacturing a holder, comprising the steps of:
cutting, from sheet material, a shape of the holder including a main section, a first side panel, and a second side panel, wherein the main section includes a base, a back panel, and a front panel;
folding, along a back edge of the base, the back panel towards the base;
folding, along a front edge of the base, the front panel towards the base;
folding, along a first edge of the main section, the first side panel towards the main section;
attaching, along the first edge of the main section, the first side panel to the main section;
folding, along a second edge of the main section, the second side panel towards the main section; and
attaching, along the second edge of the main section, the second side panel to the main section.

16. The method of claim 15, wherein the sheet material is selected from the group consisting of plastic and metal.

17. The method of claim 15, further comprising attaching the first side panel to the main section using a method selected from the group of melting, welding, and using adhesive.

18. The method of claim 15, further comprising
cutting, from the sheet material, an opening in the back panel, and
folding, along the opening, a kickstand from the back panel.

19. The method of claim 15, further comprising attaching, to the back panel, one of a kickstand and a wall mount.

20. The method of claim 19, wherein attaching one of the kickstand and the wall mount is performed by one selected from the group of a magnetic material, an adhesive, a welding, a screw, and a nail.
